(19) United States
(12) Patent Application Publication
(10) Pub. No.: US 2021/0261721 A1
(43) Pub. Date: Aug. 26, 2021

(54) USE OF HETEROCYCLIC AMINES CONTAINING PRIMARY OR SECONDARY AMINES AS A POLYMER CATALYST OR HARDENER

(71) Applicant: Zymergen Inc., Emeryville, CA (US)

(72) Inventors: Szymon Kosinski, San Francisco, CA (US); Stephen Lo, San Francisco, CA (US); Timothy Mauldin, Cupertino, CA (US); Shilpa Naresh Raja, Emeryville, CA (US); Nicole G. Ricapito, Greenwhich, NY (US); Adam Safir, Berkeley, CA (US)

(73) Assignee: Zymergen Inc., Emeryville, CA (US)

(21) Appl. No.: 17/250,186

(22) PCT Filed: Jun. 14, 2019
(86) PCT No.: PCT/US2019/037370

§ 371 Date: Dec. 10, 2020

Related U.S. Application Data
(60) Provisional application No. 62/685,837, filed on Jun. 15, 2018.

(51) Int. Cl. C08G 59/50; C08K 5/3445; C08G 59/56; C08J 5/04; C08K 7/02

(52) U.S. Cl. CPC C08G 59/5073; C08K 5/3445; C08K 7/02; C08J 5/04; C08G 59/56

(57) ABSTRACT

An epoxy resin composition comprises about 70 wt % to about 95 wt % by weight of the composition of an epoxy component; and a curing component comprising about 5 wt % to about 30 wt % by weight of the composition, wherein the curing component is includes an imidazole; wherein the epoxy component and the curing component react together at a temperature of about 100 C to about 130 C to form a substantially cured reaction product in about 10 minutes or less and the cured product shows high tensile and flexural strength.

### CROSS-REFERENCE TO RELATED APPLICATIONS

This application claims the benefit of U.S. provisional application No. 62/685,837, filed Jun. 15, 2018, which is hereby incorporated by reference in its entirety.

### STATEMENT AS TO RIGHTS TO INVENTIONS MADE UNDER FEDERALLY SPONSORED RESEARCH AND DEVELOPMENT

This invention was made with Government support under Agreement No. HR0011-15-9-0014, awarded by DARPA. The Government has certain rights in the invention.

### FIELD OF THE DISCLOSURE

The present disclosure relates generally to the area of polymer resin compositions for manufacturing composite parts and, more particularly, to fast curing epoxy resin compositions yielding cured products with high tensile and flexural strength suitable for use in applications that require such properties.

### BACKGROUND

It is well known that thermosetting resin compositions or systems find applications in binding or impregnating various materials, such as glass fibers, carbon fibers mats or wovens, as well as other reinforcing materials. Manufacturing techniques for such composite structures are also known and can vary. Practical conditions of molding vary based on industry ranging from consumer goods over electronics to energy and transportation. Also, there are different resin systems used for either high or low pressure molding, for example, under partial vacuum to improve resin penetration into the reinforcement.

Thermosets include polyester, epoxy, phenolic, vinyl esters, polyurethanes, silicones, polyamides, polyimides, and combinations thereof. The resins range from liquids to powders but are rarely used as pure resins.

Aside from reinforcement materials to contribute to mechanical properties, the resins require curing agents, hardeners, and other additives such as inhibitors and plasticizers. Additional ingredients may be required to confer specific properties onto the composite, such as flame retardancy, ultraviolet stability, electrical conductivity, moisture or gas penetration hindrance, and others.

The amount of additives mixed into a thermoset resin is often substantial and can extent to a third or more of the resin weight thereby interacting with the mechanical properties of the final product after curing. For example, conventional epoxy systems require 20-60 phr of hardener. The curative concentration is expressed in parts per hundred or phr and reflects amount in, e.g., grams to be mixed with 100 grams of resins. JEFFAMINE® D230 sold by Huntsman Corp. (The Woodlands, Tex.) is regularly used at 32 phr for epoxy resins, diethylenetriamine (‘DETA’) hardener at 21 phr, aminoethylpiperazine (AEP) at phr of 23. Accordingly, there is a need in the industry to achieve alternatives that reduces the amount of additives or combines functionalities such as, e.g., curing and hardening in order to avoid loss in performance of the thermoset while not impeding on conventional processing techniques.

Resin transfer molding (‘RTM’) is an increasingly common form of molding wherein a catalyzed, low viscosity resin composition is pumped into a mold under pressure, displacing the air at the edges, until the mold is filled. The mold can be packed with fibers preform or dry fiber reinforcement prior to resin injection. Once the mold is filled with resin, the resin cure cycle begins wherein the mold is heated to a temperature of about 100° C. or greater and the resin polymerizes to a rigid state

In the automotive industry, high-pressure resin transfer molding (‘HP-RTM’) is one type of manufacturing solutions used by OEMs and their suppliers to manufacture automotive structures. Such equipment typically utilizes intelligent or computerized filling processes with closed loop control, as well as a high-pressure metering system with sensors for monitoring internal mold pressure. Using closed loop control, resin injection can be managed and controlled. After the mold is closed, a high compression force is applied and the resin is injected at a high pressure of about 30 to about 100 bar (atm), completing impregnation and curing the resin.

In order to meet manufacturing demands, the resin system used needs to have a cure time of about 10 minutes or less, preferably about 5 minutes or less at typical molding temperatures of about 120° C. to about 140° C., and yield substantially fully cured composite parts having a resin glass transition temperature (‘T_{g}’) of greater than 130° C. without the use of a post cure or multifunctional resins. Resin systems used to manufacture such composite parts, particularly thermosetting polymer composite parts, prepared by a crosslinking reaction using an appropriate curing agent and epoxy resin, desirably have the following properties: (a) low viscosity suitable for HP-RTM (e.g., about 120 cP or less at an injection temperature of about 120° C.); (b) fast cure reaction rate (e.g., about 5 minutes or less at 120° C. or about 3 minutes or less at 130° C.); (c) are substantially fully cured at the end of the reaction period (e.g., about 95 to 100% cured) and therefore do not require post-curing after molding; and (d) have high resin T_{g}'s (e.g., greater than about 120° C.) and high composite T_{g}'s (e.g., greater than about 130° C.). One skilled in the art, however, recognizes that it is difficult to formulate epoxy resin compositions having all the properties desirable for manufacturing composite structures that will cure rapidly. For example, it is usually difficult to achieve ultimate T_{g} of the epoxy, normally attainable under slow curing conditions, when curing epoxy rapidly. Typically, the T_{g} of rapidly cured samples are lower by 20 degrees than those of slowly cured ones.

Different resin systems or formulations have been known and available for many years. These systems typically include one or more epoxy resins such as epoxy novolac resins and/or phenols such as those based on bisphenol-A (‘BPA’) and bisphenol-F (‘BPF’), among others. However, the epoxy resin used can affect different properties of the resin system, such as the mechanical properties and viscosity of the system.

Conventionally, the resin formulation also includes a hardener or curing agent such as polyethyleneimine; cycloaliphatic anhydride; dicyanamide (‘DICY’); imidazoles, such as N-(3-aminopropyl)imidazole (‘API’); and amines, such as diethylenetriamine (‘DETA’) and 1,3-bis(aminomethyl)cyclohexane (‘1,3-BAC’). The resin formulation may also require an accelerator or catalyst for accelerating the reactivity of the curing agent with the epoxy. However, the combinations of epoxies, hardeners and catalyst can negatively affect properties noted above needed to work in HP-RTM molding manufacturing processes. Therefore, there is a need for fast curing epoxy compositions suitable for use in HP-RTM manufacturing processes that meets the manufacturing requirements of low viscosity, fast cure and high resin T_{g}'s. These needs are addressed by the embodiments of the present disclosure as described below and defined by the claims that follow.

### SUMMARY OF THE DISCLOSURE

In a first aspect, an article comprises a cured polymer. The cured polymer includes a tensile strength as determined by ISO 527-1 (2012) of not less than 10,000 psi (68,948 kPa). Alternatively, the cured polymer can include a flexural strength as determined by ISO 178 (2010) of not less than 17,000 psi (117,211 kPa). In addition to the tensile or the flexural strength, the cured also includes an elongation at break as determined by ISO 527-1 (2012) of at least 2% or a flexural strain as determined by ISO 178 (2010) of at least 4%.

In a second aspect, a resin composition includes about 70 wt % to about 98 wt % by weight of the resin composition of at least one polymer component. The resin composition further includes a curing component comprising 2 wt % to about 30 wt % by weight of the composition. The curing component can include a chemical that has a secondary amine or a primary amine. The chemical can further include a tertiary amine, an aromatic amine, or an imine. Moreover, the chemical can have a molecular weight in a free-base form of greater than 70 g/mol.

In a third aspect, a process comprises mixing a curing component and a polymer component to form a resin. The process further includes transferring the resin into a mold. The process can further include curing the resin at a curing temperature T_{c} of less than 120° for not more than 10 minutes. Moreover, the process can include removing a substantially cured article from the mold. In embodiments, the article includes a tensile strength as determined by ISO 527-1 (2012) of not less than 10,000 psi (68,948 kPa) or a flexural strength as determined by ISO 178 (2010) of not less than 17,000 psi (117,211 kPa). Moreover, the article can have an elongation at break as determined ISO 527-1 (2012) of at least 2% or a flexural strain as determined by ISO 178 (2010) of at least 4%.

In a fourth aspect, an epoxy resin composition comprises about 70 wt % to about 95 wt % by weight of the composition of an epoxy component. The epoxy resin can further include a curing component comprising about 5 wt % to about 30 wt % by weight of the composition. The curing component includes an imidazole. The imidazole can be selected from

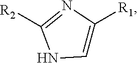

wherein R₁ and R₂ are not concurrently hydrogen and are selected from the group consisting of amino alkyl, hydroxy alkyl, amino-hydroxy alkyl, and any combination thereof. Moreover, the epoxy component and the curing component react together at a temperature of about 100° C. to about 130° C. to form a substantially cured reaction product in about 10 minutes or less. Even further, the cured reaction product includes a tensile strength as determined by ISO 527-1 (2012) of not less than 10,000 psi (68,948 kPa) or a flexural strength as determined by ISO 178 (2010) of not less than 17,000 psi (117,211 kPa). The cure reaction can also include an elongation at break as determined by ISO 527-1 (2012) of at least 2% or a flexural strain as determined by ISO 178 (2010) of at least 4%.

### BRIEF DESCRIPTION OF THE DRAWINGS

Embodiments are illustrated by way of example and are not limited in the accompanying figures.

FIG. 1 displays a reaction pathway for epoxy curing.

FIG. 2 illustrates mechanical properties and glass transition temperatures of various epoxy formulations.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the disclosure. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this disclosure belongs. The materials, methods, and examples are illustrative only and not intended to be limiting. To the extent not described herein, many details regarding specific materials and processing acts are conventional and may be found in textbooks and other sources within the composites, polymers, thermosets and polymer formulations.

As described above as the first aspect in the Summary of the Disclosure, the cured polymer can have a tensile strength as determined by ISO 527-1 (2012) of not less than 10,000 psi (68,948 kPa) or a fle flexural strength as determined by ISO 178 (2010) of not less than 17,000 psi (117,211 kPa). In one embodiment, the tensile strength can be not less than 10,500 psi (72,395 kPa), such as not less than 11,000 psi (75,843 kPa), not less than 11,300 psi (77,911 kPa), not less than 11,500 psi (79,290 kPa), not less than 11,800 psi (81,359 kPa), not less than 12,000 psi (82,738 kPa), not less than 12,200 psi (84,117 kPa), not less than 12,400 psi (85,495 kPa), not less than 12,600 psi (86,874 kPa), or not less than 12,800 psi (88,253 kPa).

In another embodiment, the flexural strength can be not less than 17,500 psi (120,659 kPa), such as not less than 18,000 psi (124,106 kPa), not less than 18,500 psi (127,554 kPa), not less than 19,000 psi (131,001 kPa), not less than 19,500 psi (134,448 kPa), not less than 20,000 psi (137,896 kPa), not less than 20,200 psi (139,275 kPa), not less than 20,400 psi (140,653 kPa), not less than 20,600 psi (142,032 kPa), not less than 20,800 psi (143,411 kPa), not less than 21,000 psi (144,790 kPa), not less than 21,200 psi (146,169 kPa), not less than 21,400 psi (147,549 kPa), not less than 21,600 psi (148,927 kPa), or not less than 21,800 psi (150,306 kPa).

In further addressing the first aspect, the cured polymer can have an elongation at break as determined by ISO 527-1 (2012) of at least 2% or a flexural strain as determined by ISO 178 (2010) of at least 4%. In one embodiment, the elongation at break can be at least 2.1%, such as at least 2.2%, at least 2.3%, at least 2.4%, at least 2.5%, at least 2.6%, at least 2.7%, at least 2.8%, at least 2.9%, at least 3%, at least 3.2%, at least 3.4%, at least 3.6%, at least 3.8%, at least 4%, at least 4.3%, at least 4.5%, at least 4.8%, at least 5%, at least 5.3%, at least 5.5%, at least 5.8%, or at least 6%.

In another embodiment, the cured polymer can have a flexural strain that is at least 4.1%, such as at least 4.2%, at least 4.3%, at least 4.4%, at least 4.5%, at least 4.6%, at least 4.7%, at least 4.8%, at least 4.9%, at least 5%, at least 5.2%, at least 5.4%, at least 5.6%, at least 5.8%, at least 6%, at least 6.3%, at least 6.5%, at least 6.8%, at least 7%, at least 7.3%, at least 7.5%, at least 7.8%, or at least 8%.

In one further embodiment, the cured polymer can have a glass transition temperature T_{g} as determined by differential scanning calorimetry according to ASTM D7028 of at least 120° C., such as at least 125° C., at least 130° C., at least 132° C., at least 134° C., at least 136° C., at least 138° C., at least 140° C., at least 142° C., at least 144° C., at least 146° C., at least 148° C., at least 150° C., at least 152° C., or at least 154° C.

In one further embodiment, the T_{g} is greater than the curing temperature T_{cure}, i.e. the temperature during processing at which the cured polymer is obtained from a mixture of a resin, a curing component, and any other optional additives. In one particular embodiment, the difference between T_{g} and T_{cure} is at least 10° C., such as at least at least 15° C., at least 20° C., at least 25° C., at least 30° C., at least 35° C., at least 40° C., at least 45° C., or at least 50° C.

In one embodiment, the cured polymer of the polymer can include an epoxy polymer, a polyester, a polyamide, a polyimide, a polyurethane, a polyacrylate, a polyacrylamide, a polyketone, or any combination thereof. In one particular embodiment, the cured polymer consists essentially of an epoxy polymer. In this regard, a polymer is understood to be the reaction product of a polymer component and a curing component. For example, an epoxy polymer is understood to be the reaction product of an epoxy component and a curing component.

The polymer component can be present in an amount of about 50 wt % to about 99 wt % by weight of the composition. In one embodiment, the polymer component is present in an amount of about 70 wt % to about 98 wt % by weight of the composition. The polymer component can be a single resin, or it can be a mixture or blend of mutually compatible resins.

In addressing epoxy polymers, an epoxy resin component and a curing component. The epoxy component can be present in an amount of about 50 wt % to about 98 wt % by weight of the composition. In one embodiment, the epoxy component is present in an amount of about 70 wt % to about 95 wt % by weight of the composition. The epoxy resin can be a single resin, or it can be a mixture or blend of mutually compatible epoxy resins.

Suitable epoxy resins include, but are not limited to, bi-functional epoxies, based on phenols such as 2,2-bis-(4-hydroxyphenyl)-propane (a/k/a bisphenol A) and bis-(4-hydroxyphenyl)-methane (a/k/a bisphenol F). These phenols can be reacted with epichlorohydrin to form the diglycidyl ethers of these polyhydric phenols (e.g., bisphenol A diglycidyl ether, or DGEBA). Multifunctional epoxy resin, as utilized herein, describes compounds containing two (i.e., di-functional) or more (i.e., multi-functional) 1,2-epoxy groups per molecule. Epoxide compounds of this type are well known to those of skill in the art.

The epoxy component can be an aliphatic epoxy resin, which include glycidyl epoxy resins and cycloaliphatic (alicyclic) epoxide. Glycidyl epoxy resins include dodecanol glycidyl ether, diglycidyl ester of hexahydrophthalic acid, and trimethylolpropane triglycidyl ether. These resins typically display low viscosity at room temperature (10-200 mPa·s) and can be used to reduce the viscosity of other resins. Examples of suitable cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, vinylyclohexene diepoxides; limonene diepoxide; bis(3,4-epoxycyclohexylmethyl)pimelate; dicyclopentadiene diepoxide; and other suitable cycloaliphatic epoxides. The cycloaliphatic epoxides also display low viscosity at room temperature; however, their room temperature reactivity is rather low, and high temperature curing with suitable accelerators is normally required.

In another embodiment, epoxy novolac resins, which are the glycidyl ethers of novolac resins, can be used as multifunctional epoxy resins in accordance with the present disclosure. Suitable epoxy novolac resins include polyepoxides (epoxy phenol novolac resin) and epoxy cresol novolac resin. These are typically highly viscous resins having a high epoxide functionality of around 2 to 6, providing high temperature and chemical resistance when cured but low flexibility.

The viscosity of the epoxy resin composition can be reduced by modifying the epoxy component. The epoxy component can comprise at least one multifunctional epoxy resin and/or one or more monofunctional epoxy resins. Monoepoxides include, but are not limited to, styrene oxide, cyclohexene oxide and the glycidyl ethers of phenol, cresols, tert-butylphenol, other alkyl phenols, butanol, 2-ethylhexanol, C₄ to C₁₄ alcohols, and the like, or combinations thereof. The multifunctional epoxy resin can also be present in a solution or emulsion, with the diluent being water, an organic solvent, or a mixture thereof.

Other epoxy resins suitable for use in the present invention include higher functionality epoxies such as the glycidylamine epoxy resins. Examples of such resins include triglycidyl-p-aminophenol (functionality 3) and N,N,N,N-tetraglycidyl-4,5-methylenebis benzylamine (functionality 4). These resins are low to medium viscosity at room temperature, making them easy to process.

The resin composition further includes a curing component. In embodiments, the curing component includes a secondary amine or primary amine. The curing component can further include a tertiary amine, an aromatic amine, or an imine. Moreover, the curing component can include a molecular weight in a free-base form of greater than 70 g/mol, such as greater than 75 g/mol, greater than 80 g/mol, greater than 85 g/mol, greater than 90 g/mol, greater than 95 g/mol, greater than 100 g/mol, greater than 105 g/mol, greater than 110 g/mol, greater than 120 g/mol, greater than 130 g/mol, greater than 140 g/mol, greater than 150 g/mol, or greater than 160 g/mol.

In one embodiment, the curing component can include a primary amine, a secondary amine and an aromatic amine. In another embodiment, the curing component can include two primary amines, one secondary amine, and an aromatic amine. In yet another embodiment, the aromatic amine includes a moiety selected from an imidazole, a pyridine, a pyrimidine, a pyrazine, a benzimidazole, a thiazole, an oxazole, a pyrazole, an isooxazole, an isothiazole, or any mixture thereof

In another embodiment, the curing component is selected from

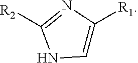

In the foregoing imidazole, R₁ and R₂ can be not concurrently hydrogen. In one embodiment, R₁ and R₂ can be selected from the group consisting of amino alkyl, hydroxy alkyl, amino-hydroxy alkyl, or any combination thereof.

In yet another embodiment, the curing component can be selected from

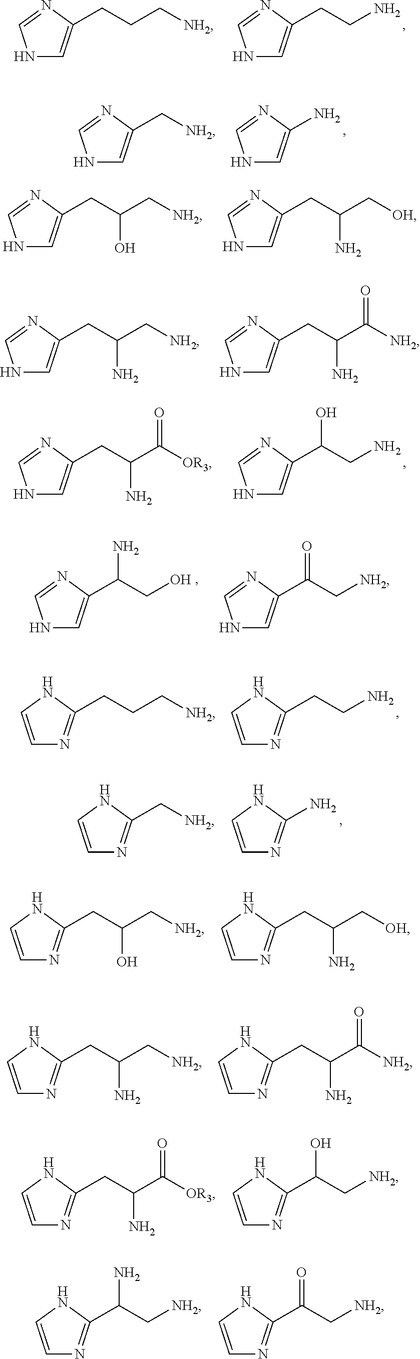

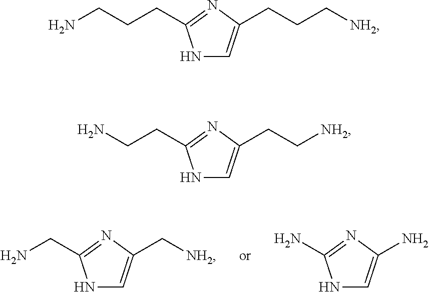 [SMILES: NCCCc1c[nH]c(CCCN)n1 ; NCCc1c[nH]c(CCN)n1 ; NCc1c[nH]c(CN)n1 ; Nc1c[nH]c(N)n1]

or any enantiomers or diastereomers of the foregoing. For structures comprising a group R₃, the group R₃ can be selected from hydrogen, methyl, ethyl, n-propyl, i-propyl, n-butyl, sec-butyl, tert-butyl, or isobutyl. In yet another embodiment, the curing component consists essentially of histamine. In one further embodiment, the curing component consists essentially of 2-(2-aminoethyl)imidazole.

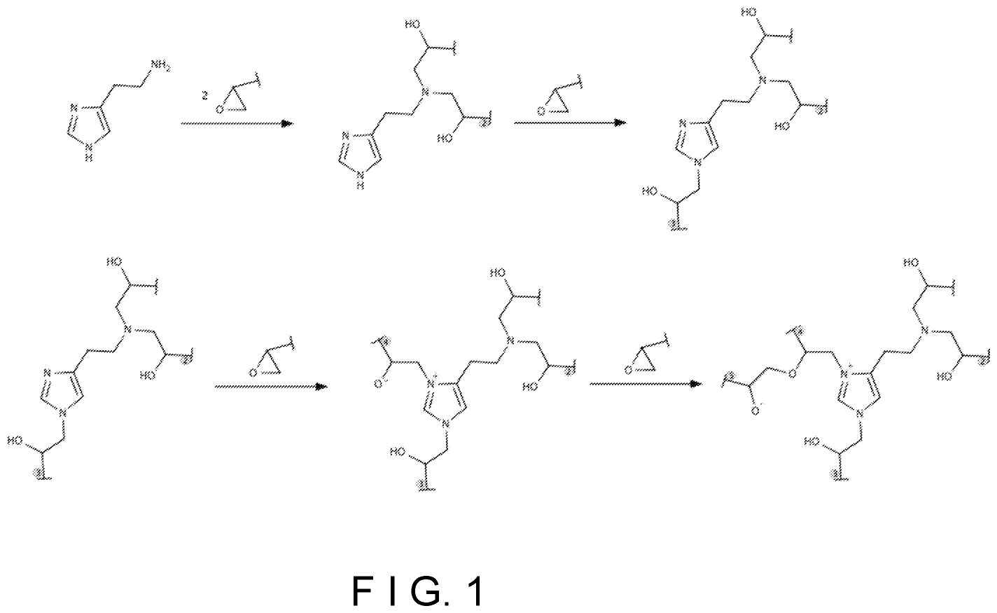

In addressing FIG. 1 of the present disclosure, an exemplary curing reaction on epoxy resin is displayed. More specifically, histamine is shown as a curing component. As can be seen in the first step, the primary amine is most reactive and reacts with two epoxy group of an epoxy resin. Thereby, the primary amine becomes a linker in a first chain of an epoxy polymer back bone. In the second step, the secondary amine of the imidazole ring reacts with one epoxy group. Accordingly, the secondary amine becomes the end unit of a second epoxy polymer chain. As can be seen in the third step, as the reaction carries on, the heterocyclic aromatic amine becomes active and reacts with an epoxy group, thereby generating a zwitterion. The zwitterion alkoxide can actually further react with another epoxy group thereby further catalyzing polymerization of epoxy itself. For clarity, chain transfer, i.e., where the activity of a growing polymer chain is transferred to another molecule (P•+XR→PX+R•) is omitted in this polymerization process, but it may also contribute to polymerization of epoxy itself. Since prior to the third step (aromatic amine reaction), the epoxy system is already crosslinked, the polymerization that began with the aromatic amine and comprises alkoxides can actually further grow and link all unreacted epoxy groups, either directly or via a chain transfer process, or even react with another polymer chain by hydrogen bond or nucleophilic substitution of a hydroxyl group, which results macroscopically in a stronger polymer material. Similar hardeners such as 1-(aminopropylene)imidazole (‘API’), do not have a secondary amine that reacts with epoxy, thereby missing a potential to crosslink epoxy prior to epoxy homopolymerization.

Accordingly, the presence of protic amino and non-protic imino or aromatic amines in the curing component have an effect on the tensile and flexural properties of the resulting cured polymer. Moreover, the distance of the protic and non-protic nitrogens can affect the resulting crosslinking reactivity of the curing agent, since the distance determines how close the polymer chains that the protic amines form come to each other. Therefore, in one embodiment, the primary amine of the curing component can be within a radius of less than 100 nm, less than 90 nm, less than 80 nm, less than 70 nm, less than 60 nm, or less than 50 nm from the secondary amine nitrogen. In another embodiment, the aromatic amine or imine can be within a radius of less than 50 nm, less than 40 nm, less than 30 nm, less than 20 nm from the secondary amine nitrogen.

In another embodiment, the curing component can include a product that is a naturally occurring substance. In one particular embodiment, the curing component can be selected from

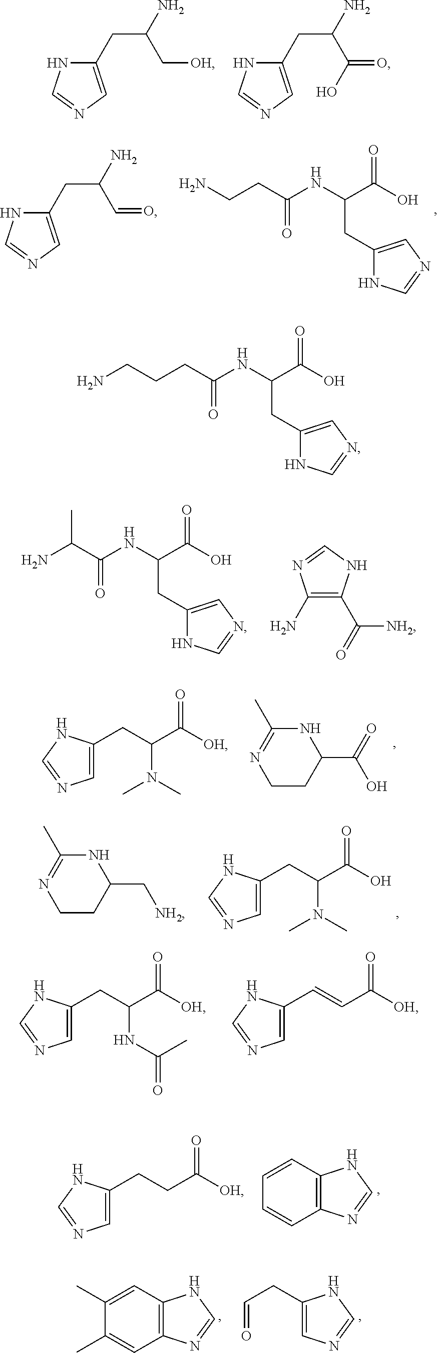

or any enantiomers or diastereomers of the foregoing.

In addressing the polymer component, in one embodiment, the polymer component can be selected from an epoxy component, a carboxylic acid component, a carboxylic ester component, a carboxylic anhydride component, an isocyanate component, an acrylonitrile component, a urea component, an aldehyde component, a ketone component, or any combination thereof. In another embodiment, the polymer component and the curing component react together at a temperature of about 90° C. to about 140° C. in less than 10 minutes to substantially form a cured polymer. In another embodiment, they react together at a temperature of about 100° C. to about 135° C. in less than 8 minutes, less than 6 minutes, less than 5 minutes, or less than 4 minutes to substantially form a cured polymer.

Accordingly, a process comprises mixing a curing component and a polymer component to form a resin. The process further includes transferring the resin into a mold. The process can further include curing the resin at a curing temperature T_{c} of less than 120° for not more than 10 minutes. Moreover, the process can include removing a substantially cured article from the mold. In embodiments, the article includes a tensile strength as determined by ISO 527-1 (2012) of not less than 10,000 psi (68,948 kPa) or a flexural strength as determined by ISO 178 (2010) of not less than 17,000 psi (117,211 kPa). Moreover, the article can have an elongation at break as determined ISO 527-1 (2012) of at least 2% or a flexural strain as determined by ISO 178 (2010) of at least 4%.

In one embodiment, the curing component can be added at less than the theoretical stoichiometry needed to have all reactive sites of the polymer component reacted with the curing agent. This can be understood in light of FIG. 1 and the foregoing description. Since the aromatic amine creates a zwitterion, epoxy functions can homo-polymerize.

In one embodiment, the curing component can be added at not greater than 90% of the theoretical stoichiometry, such as at not greater than 80%, at not greater than 70%, at not greater than 60%, at not greater than 55%, at not greater than 50%, at not greater than 45%, at not greater than 40%, at not greater than 35%, at not greater than 30%, or at not greater than 25% of the theoretical stoichiometry.

In another embodiment, the polymer component includes a number of reactive functionalities nᵣ, e.g., epoxy functions, and the curing component includes a curing functionality n_{c}, e.g., primary amines (factor 2), secondary amine (factor 1), and heterocyclic aromatic-amines (factor 1). For a 100% theoretical stoichiometry, nᵣ=n_{c}. In one embodiment of the present disclosure the resin has a ratio of n_{c}:nᵣ of not greater than 0.98, not greater than 0.95, not greater than 0.9, not greater than 0.85, not greater than 0.8, not greater than 0.75, not greater than 0.7, not greater than 0.65, not greater than 0.6, not greater than 0.55, not greater than 0.5, not greater than 0.45, not greater than 0.4, not greater than 0.38, not greater than 0.36, not greater than 0.34, not greater than 0.32, not greater than 0.30, not greater than 0.28, not greater than 0.26, not greater than 0.24, not greater than 0.22, not greater than 0.2, not greater than 0.18, or not greater than 0.16.

In another embodiment, the resin can further include reinforcement fibers. In an embodiment, the reinforcing fiber can be selected from glass fiber, fiberglass, silicon carbide fiber, disilicon carbide fiber, carbon fiber, graphite fiber, boron fiber, quartz fiber, aluminum oxide fiber, carbon nanotubes, nano composite fibers, polyaramide fiber, poly(p-phenylene benzobisoxazole) fiber, ultrahigh molecular weight polyethylene fiber, high and low density polyethylene fiber, polypropylene fiber, nylon fiber, cellulose fiber, natural fiber, biodegradable fiber, or combinations thereof.

### Experimentals:

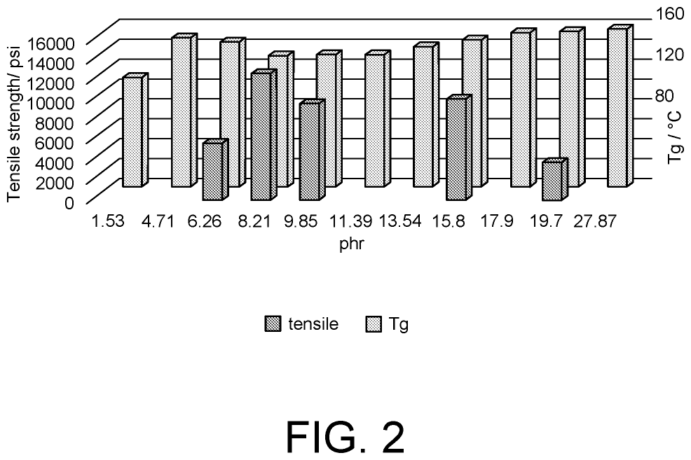

FIG. 2 discloses tensile strength and glass transition temperature results for epoxy polymers (from Epon 828) with histamine at various phr. As can be seen, the Histamine can cure epoxy at parts per hundred (phr's) of 6-16, lower than at theoretical (stoichiometric) phr of 20 with excellent thermo-mechanical properties, which are equal or better than those at theoretical phr (as measured by T_{g}, tensile and flexural strength and hardness). When used with Epon 828, histamine at phr of 7.88 (40% of theoretical phr) gives epoxy with T_{g} of ˜150° C., tensile strength of epoxy 87.5 MPa, flexural strength 152.5 MPa and strain (elongation) 5.1% and 6.3% respectively.

For comparison—typical values for Jeffamine D230 at phr 32 (about 4 times more D230 used than histamine) are: 76 MPa tensile and 93 MPa flexural. The explanation of this unusual behavior of histamine lies in balancing mechanism of action of histamine between cross-linking (normal epoxy curing mechanism) and homopolymerization of epoxy. Histamine acts efficiently as a catalyst for pre-preg formulations when used together with 2-cyanoguanidine (DICY) and pre-preg epoxy resins in place of commonly used 2-methylimidazole. Histamine powder may be used for one-component epoxy.

Histamine because of its melting point of 84° C. can be isolated as solid and milled to a fine powder. Basic experiment was performed that such fine powder can be mixed at room temperature with Epon 828 epoxy resin at histamine phr of 19.7 to produce a paste that remained as a viscous liquid for longer periods of time; much longer than when histamine was used as liquid (either melted histamine or warmed up adduct.) The time that paste remained liquid is temperature dependent and at lower temperatures paste remains viscous longer. Paste, when stored at room temperature, solidified on the next day. There is a need for one-part epoxy adhesives that eliminate need for weighing and mixing of components. Histamine powder has ability to produce such adhesives.

Experiment 1: Synthesis of Histamine on 500 g Scale

Histamine dihydrochloride (905 g, 4.92 moles) was dissolved in 825 g of water and 786.7 g of 50% sodium hydroxide (9.84 moles) was added. The pH of the solution was 10. The reaction mixture was concentrated on rotary evaporator and 750 mL of isopropanol (IPA) was added. Sodium chloride was filtered off and another portion of 750 mL of IPA was added. The mixture was concentrated and left under high vacuum overnight. The product crystallized out as solid mass with a yield of 470 g (86%). Similarly, the procedure can be performed using sodium carbonate in iso-propanol or essentially any inorganic base.

Experiment 2: Histamine-13

The melting point of histamine is 84° C. When isolated as a free base, it crystallizes in the form of large fused crystals. The crystals can be milled to form powdery solids. Histamine powder is hygroscopic, but the milled histamine can be stored for long periods of time under dry and sealed containment. For liquid formulations, an adduct with Epon 828 (DGEBA) in a 13:1 mol ratio (“Histamine-13”) was developed. This form remains a viscous liquid for long periods of time and can easily be reheated to workable liquid.

Experiments 3-10: Epoxy Thermoset Samples

Cured epoxy thermoset plastic discs were prepared with the use of the above-mentioned melted or warmed-up Histamine-13 and additional Epon 828 (DGEBA). The parts of histamine per hundred parts of epoxy resin (PHR) was calculated and the corresponding quantities of histamine were speed-mixed with epoxy resin using a dual asymmetric centrifugal laboratory mixer system for 5 minutes at 2500 rpm in a disposable container. This procedure eliminated air bubbles and/or produced homogenous suspension of components (for pre-preg evaluation). The samples were either cured in epoxy sample discs or aluminum molds (size 10 inch×10 inch×0.25 inch). The samples were poured and left overnight at room temperature (RT). The partially cured samples were then post-cured in an oven at 125° C. for 10 minutes to 1-3 hours, unless stated otherwise.

Table 1 discloses the relationship of histamine content and its corresponding T_{g} value after postcuring for 10 minutes

TABLE 1
Histamine content versus T_{g}.

| Experi- | Wt. % of | Phr of | |
|---|---|---|---|
| ment | Histamine-13 | histamine | T_{g}/° C. |
| 3 | 1.5 | 1.52 | 110 |
| 4 | 4.5 | 4.71 | 150 |
| 5 | 5.9 | 6.27 | 146 |
| 6 | 7.6 | 8.23 | 132 |
| 7 | 10.2 | 11.36 | 133 |
| 8 | 11.9 | 13.51 | 141 |
| 9 | 15.2 | 17.92 | 155 |
| 10 | 21.8 | 27.88 | 159 |

As can be seen from Table 1, at low histamine concentrations (Ex. 4 and 5), the resulting thermoset yields a T_{g} that is similar to the T_{g} at around stoichiometric combinations (Ex. 9 and 10, 19.7 phr being 100% stoichiometric), while in between, the T_{g} undergoes a minimum with increasing histamine concentration, however the T_{g} never drops below 132° C. Moreover, the prepared samples were determined with a Shore D hardness tester and all formulations in Table 1 showed a close range of hardness between 88 and 89 D

Experiments 11-15: Mechanical Properties at Various Phr

The mechanical performance of histamine cured plates (10 inch×10 inch×0.25 inch) was evaluated at phr levels of 5.91, 7.88, 9.85 and 15.8 (30%, 40%, 50% and 80% of theoretical phr) following ISO 527 tensile testing and ISO 178 flexural testing. Plates were prepared as described above. After curing, they were even in coloring and had not any fractal patterns other than the one at theoretical phr of 19.7.

Multiple specimens were cut from the plates and the force was applied to determine force required to break specimen and the extent to which the specimen stretches, elongates or bends. The data are presented in Table 2 (nd=not determined).

TABLE 2
Tensile and flexural properties of thermosets at various histamine content.

| | | % | tensile | tensile | | flexural | flexural | |
|---|---|---|---|---|---|---|---|---|
| | | theor. | strength | strain | modulus | strength | strain | modulus |
| Ex. | phr | phr | [MPa] | [%] | [GPa] | [MPa] | [%] | [GPa] |
| 11 | 5.91 | 30% | 39.33 | 1.5 | 3.052 | 91.5 | 3.40% | 3.105 |
| 12 | 7.88 | 40% | 87.51 | 5.06 | 3.403 | 152.48 | 6.34% | 3.441 |
| 13 | 9.85 | 50% | 66.95 | 3.02 | 3.316 | 138.13 | 5.88% | 3.476 |
| 14 | 15.8 | 80% | 69.06 | 3.52 | 3.098 | 127.31 | 5.27% | 3.273 |
| 15 | 19.7 | 100% | 26.54 | 0.9 | 3.211 | nd | nd | Nd |

Unexpectedly, histamine at an amount less than the theoretical phr of 100%, more specifically at a range not less than 30% phr and less than 100% phr, the samples show very high tensile and flexural strengths. The mechanical performance of histamine cured Epon 828 epoxy plates shows high strength over range of phr of 40-80% theoretical phr. At 40% of theoretical phr (phr=7.88) the tensile strength was measured to be the highest: 87.5 MPa (12,692 psi) and 5.1% elongation at break. The flexural strength was measured to be highest at 40% of theoretical phr as well, namely 152.48 MPa (22,118 psi) and 6.3% strain at break. At both ends of tested range of phr, namely: above 80% and below 40% of theoretical phr, the strength of histamine cured epoxy plates drops significantly.

Experiments 16 and 17: Histamine as Components of Pre-Pregs

Pre-preg materials are usually composed of three components: 1) high viscosity epoxy resin; 2) a curing agent; and 3) a cure accelerator. Epotec's YDPN 638 (a semi-solid phenol novolac based epoxy) was used as the resin, 7% of Evonik's Dicyanex 1408 (2-cyanoguanidine, DICY) was used as the hardener and 1% of melted histamine (Experiment 16) or 1% of Evonik's Imicure AMI2 (2-methyl imidazole) as the accelerator. Histamine was evaluated as replacement of 2-methyl imidazole in pre-pregs.

Both studied pre-preg formulations produced white tacky paste after mixed warm using a high sheer dispensing impeller. After cooling the formulation remained tacky and rubbery for more than a week at room temperature. The pre-preg formulations were tested in the oven for curing speed at three different sets of temperatures and times, as shown in Table 3. The selected conditions were based on typically used for pre-pregs. When cured at 110° C. both formulations were under-cured, but cured rapidly at 120° C., as seen from the results below.

As can be seen in Table 3, histamine has catalytic properties equivalent to 2-methyl imidazole. The presence of a primary amine group as in histamine does not affect the catalytic properties or impacts storage or premature polymerization.

TABLE 3
Histamine as a catalyst

| | Experiment 16 | Experiment 17 |
|---|---|---|
| | YDPN 638 epoxy | YDPN 638 epoxy |
| | (EPOTEC) | (EPOTEC) |
| | 200 g | 200 g |
| | Histamine 2 g | 2-methyl imidazole 2 g |
| | DICY—DICYANEX | DICY—DICYANEX |
| Curing | 1408 (EVONIK) 14 g | 1408 (EVONIK) 14 g |
| conditions | T_{g}/° C. | T_{g}/° C. |
| 10 minutes at | ~150° C. | ~150° C. |
| 110° C. | (1^{st} scan) | (1^{st} scan) |
| 5 minutes at | 186° C. | 191° C. |
| 120° C. | 196° C. | 198° C. |
| | (2^{nd} scan) | (2^{nd} scan) |
| 20 minutes at | 217° C. | 219° C. |
| 120° C. | (2^{nd} scan) | (2^{nd} scan) |

Experiments 18-20: Additional Amines with Epoxy Resins

Mixtures of epoxy with amines similar to histamine were prepared with the use of standalone hardeners as listed in Table 4 with Epon 828. The amount studied corresponded to 8% of theoretical PHR to achieve catalytic effect, namely anionic homopolymerization of Epon 828.

L-Histidinol, closely related to histamine, was difficult to formulate because of high polarity and low solubility in Epon 828 and T_{g} obtained was below 60° C. 5,6-Dimethylbenzimidazole showed performance similar to histamine. Despite high melting point (205° C.) it catalyzes homopolymerization of Epon 828 due to its solubility. Homopolymerization in presence of 5,6-dimethylbenzimidazole starts at 120-130° C. and obtained epoxy has T_{g} of 158° C. as expected based on previous research

TABLE 4
Various imidazoles

| | | | Parts of | | |
|---|---|---|---|---|---|
| | | | amine | | |
| | | | per 100 | | |
| | | | parts | | |
| | | | (PHR) of | | |
| | | | Epon 828 | | |
| | | Tₘₑₗₜ/ | and Type | | T_{g} |
| Ex. | Amine | ° C. | of study | Observations | (° C.) |
| 18 | 5,6-Dimethyl- | 205 | 6.2 | cures epoxy at | 158 |
| | benzimidazole | | Catalyst | ~120° C. | |
| 19 | L-Histidinol | liquid | 2 | Cures epoxy at | <60 |
| | | | Catalyst | ~125° C. | |
| 20 | L-Histidine Na | 122 | 70.5 | Cures epoxy at | 88 |
| | salt—crown-5 | | Cross- | ~125° C. | |
| | | | linker | | |

Experiments 21-22: Conventional Amine Hardener Versus Histamine in Epoxy Resins

Cured epoxy thermoset plastic discs were prepared with the use of Jeffamine D230 and histamine and additional Epon 828 (DGEBA). The parts of Jeffamine D230 per hundred parts of epoxy resin (PHR) was 30.5 and the PHR of histamine was 7.5. The mixtures were briefly mixed and poured into molds. The samples were then placed into the rheometer to determine pot life.
Rheometer settings
Instrument: DHR-1 (TA Instruments)
Fixture: 25 mm parallel plates w/drip channel
Normal force control: 0.1 N with 0.5 N sensitivity
Test mode: Oscillation time sweep
Sampling interval: 25 s/pt
Strain: 0.1%
Angular frequency: 1 rad/s
Gap size: 500 um

Sample prep: Instrument was preheated to desired temperature before inserting premixed sample. A stopwatch was used to measure the time between sample insertion on preheated instrument and the initiation of data collection (typically 30-40 seconds). Gel time and pot life values were corrected to account for this time.

Pot life is defined as the amount of time it takes for an initial viscosity measured upon mixing to double. Timing starts from the moment the product is mixed and unless provided otherwise, is measured at room temperature (23° C.). As for the gel time, this is the time it takes until a resin becomes stringy or gel-like. Gel time is measured at an elevated temperature. Finally, cure time is the time it takes for a resin mix to fully cure at a certain temperature. The following table discloses the results of measurements.

TABLE 5
Jeffamine and Histamine comparison

| | | Cure | Gel | | |
|---|---|---|---|---|---|
| Experi- | | temp/ | time/ | Pot life/ | T_{g}/ |
| ment | Hardener | ° C. | sec | sec* | ° C.** |
| 20a | Jeffamine | 70 | 4427 | 621 | ~90 |
| 20b | Jeffamine | 100 | 963 | 375 | ~90 |
| 20c | Jeffamine | 130 | 283 | 181 | ~90 |
| 21a | Histamine | 100 | 304 | 104 | ~165 |
| 21b | Histamine | 120 | 128 | <40 | ~165 |
| 21c | Histamine | 140 | <40 | <40 | ~165 |

*Pot life/sec was measured at the indicated Cure temp
**Tg shown was for optimal Cure conditions

As can be seen in Table 5, Histamine cures faster than conventional hardener Jeffamine D230. More surprisingly, at a cure temperature of 140° C., the cure kinetics are only a fraction of those set by the benchmark hardener. Fast curing times correlate to lower cycle times during production and therefore lower costs and higher throughput. Moreover, Histamine achieves this faster kinetics while also providing a higher T_{g}. One advantage of a T_{g} above cure temperature is rapidly demolding without cooling which also contributes more rapid manufacture. Moreover, high T_{g} materials allows for applications in high temperatures environments. For example, a plastic with a high T_{g} can be situated closer to a heat source or a combustion engine

1. An article comprising a cured polymer, wherein the cured polymer includes:
(i) a tensile strength as determined by ISO 527-1 (2012) of not less than 10,000 psi (68,948 kPa) or a flexural strength as determined by ISO 178 (2010) of not less than 17,000 psi (117,211 kPa); and
(ii) an elongation at break as determined by ISO 527-1 (2012) of at least 2% or a flexural strain as determined by ISO 178 (2010) of at least 4%.

2. The article according to claim 1, wherein:
(i) the tensile strength is not less than 10,500 psi (72,395 kPa), not less than 11,000 psi (75,843 kPa), not less than 11,300 psi (77,911 kPa), not less than 11,500 psi (79,290 kPa), not less than 11,800 psi (81,359 kPa), not less than 12,000 psi (82,738 kPa), not less than 12,200 psi (84,117 kPa), not less than 12,400 psi (85,495 kPa), not less than 12,600 psi (86,874 kPa), or not less than 12,800 psi (88,253 kPa);
or wherein the flexural strength is not less than 17,500 psi (120,659 kPa), not less than 18,000 psi (124,106 kPa), not less than 18,500 psi (127,554 kPa), not less than 19,000 psi (131,001 kPa), not less than 19,500 psi (134,448 kPa), not less than 20,000 psi (137,896 kPa), not less than 20,200 psi (139,275 kPa), not less than 20,400 psi (140,653 kPa), not less than 20,600 psi (142,032 kPa), not less than 20,800 psi (143,411 kPa), not less than 21,000 psi (144,790 kPa), not less than 21,200 psi (146,169 kPa), not less than 21,400 psi (147,549 kPa), not less than 21,600 psi (148,927 kPa), or not less than 21,800 psi (150,306 kPa): and/or
(ii) the elongation at break is at least 2.1%, at least 2.2%, at least 2.3%, at least 2.4%, at least 2.5%, at least 2.6%, at least 2.7%, at least 2.8%, at least 2.9%, at least 3%, at least 3.2%, at least 3.4%, at least 3.6%, at least 3.8%, at least 4%, at least 4.3%, at least 4.5%, at least 4.8%, at least 5%, at least 5.3%, at least 5.5%, at least 5.8%, or at least 6%;
or wherein the flexural strain is at least 4.1%, at least 4.2%, at least 4.3%, at least 4.4%, at least 4.5%, at least 4.6%, at least 4.7%, at least 4.8%, at least 4.9%, at least 5%, at least 5.2%, at least 5.4%, at least 5.6%, at least 5.8%, at least 6%, at least 6.3%, at least 6.5%, at least 6.8%, at least 7%, at least 7.3%, at least 7.5%, at least 7.8%, or at least 8%.

3. (canceled)

4. The article according to claim 1, wherein the cured polymer has a glass transition temperature T_{g} as determined by differential scanning calorimetry according to ASTM D7028 of at least 120° C., at least 125° C., at least 130° C., at least 132° C., at least 134° C., at least 136° C., at least 138° C., at least 140° C., at least 142° C., at least 144° C., at least 146° C., at least 148° C., at least 150° C., at least 152° C., or at least 154° C.

5. The article according to claim 1, wherein the cured polymer includes an epoxy polymer, a polyester, a polyamide, a polyimide, a polyurethane, a polyacrylate, a polyacrylamide, a polyketone, or any combination thereof.

6. (canceled)

7. The article according to claim 1, wherein the cured polymer is a reaction product of a reaction including a curing component comprising, wherein the curing component includes
(i) a primary or secondary amine,
(ii) a tertiary amine, an aromatic amine, or an imine, and
(iii) a molecular weight in a free-base form of greater than 70 g/mol.

8. The article according to claim 7, wherein the aromatic amine includes a moiety selected from an imidazole, a pyridine, a pyrimidine, a pyrazine, a benzimidazole, a thiazole, an oxazole, a pyrazole, an isooxazole, an isothiazole, or any mixture thereof.

9. The article according to claim 7, wherein the curing component further includes a primary amine and a secondary amine.

10. The article according to claim 7, wherein the curing component is selected from 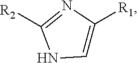
wherein R¹ and R² are not concurrently hydrogen and are selected from the group consisting of amino alkyl, hydroxy alkyl, amino-hydroxy alkyl, or any combination thereof.

11. The article according to claim 10, wherein the curing component is selected from 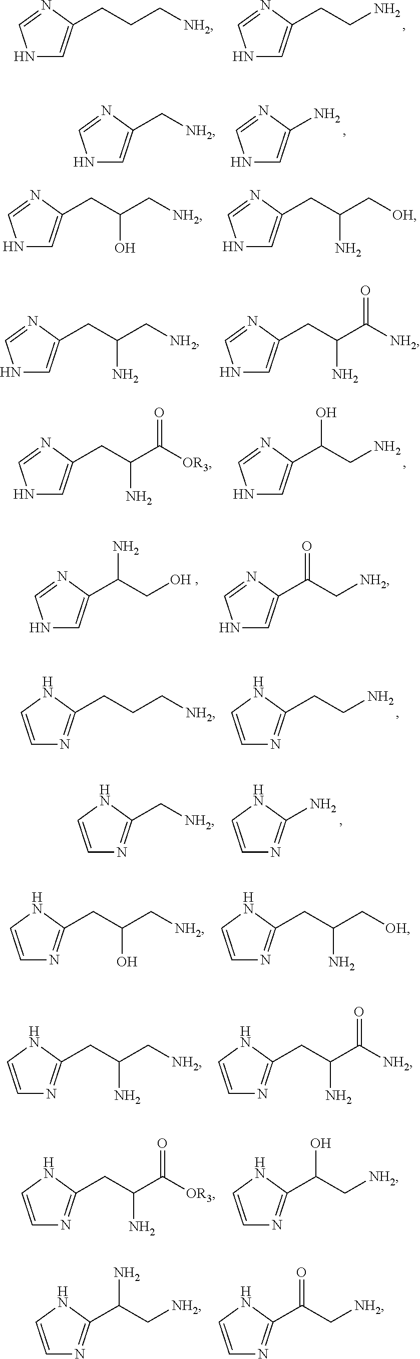 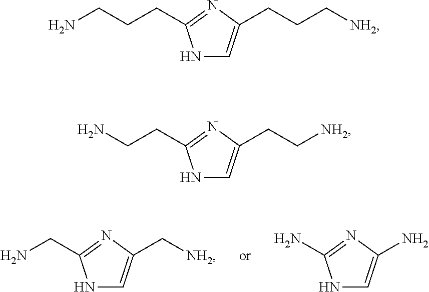
wherein R₃ is selected from hydrogen, methyl, ethyl, n-propyl, i-propyl, n-butyl, sec-butyl, tert-butyl, or isobutyl.

12. The article according to claim 7, wherein the curing component is selected from 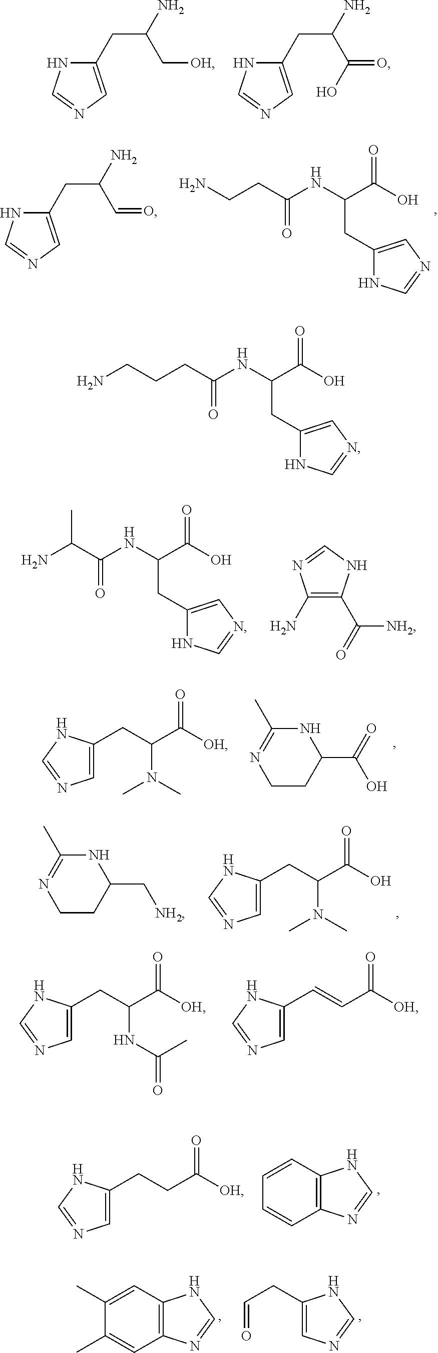
or any enantiomers or diastereomers of the foregoing.

13. A resin composition comprising:
about 70 wt % to about 98 wt % by weight of the resin composition of at least one polymer component; and
a curing component comprising 2 wt % to about 30 wt % by weight of the composition,
wherein the curing component includes
(i) a secondary amine or a primary amine,
(ii) a tertiary amine, an aromatic amine, or an imine, and
(iii) a molecular weight in a free-base form of greater than 70 g/mol.

14. The resin composition according to claim 13, wherein the curing component includes a secondary amine and a primary amine.

15. The resin composition according to claim 14, wherein the primary amine of the curing component is within a radius of less than 100 nm, less than 90 nm, less than 80 nm, less than 70 nm, less than 60 nm, or less than 50 nm from the secondary amine nitrogen; or wherein the aromatic amine or imine is within a radius of less than 50 nm, less than 40 nm, less than 30 nm, less than 20 nm from the secondary amine nitrogen.

16. (canceled)

17. The resin composition according to claim 13, wherein the polymer component is selected from an epoxy component, a carboxylic acid component, a carboxylic ester component, a carboxylic anhydride component, an isocyanate component, an acrylonitrile component, a urea component, an aldehyde component, a ketone component, or any combination thereof.

18. The resin composition according to claim 13, wherein the polymer component and the curing component react together at a temperature of about 90° C. to about 140° C. in less than 10 minutes to substantially form a cured polymer.

19. A process comprising:
mixing a curing component and a polymer component to form a resin;
transferring the resin into a mold;
curing the resin at a curing temperature T_{c} of less than 140° C. for a curing time t_{c} not more than 10 minutes; and
removing a substantially cured article from the mold, wherein the article includes:
(i) a tensile strength as determined by ISO 527-1 (2012) of not less than 10,000 psi (68,948 kPa) or a flexural strength as determined by ISO 178 (2010) of not less than 17,000 psi (117,211 kPa); and
(ii) an elongation at break as determined by ISO 527-1 (2012) of at least 2% or a flexural strain as determined by ISO 178 (2010) of at least 4%.

20. The process according to claim 19, wherein T_{c} is less than 138° C., less than 135° C., less than 130° C., less than 125° C., less than 120° C., less than 115° C., or less than 110° C.; or
the t_{c} is not more than 9 minutes, not more than 8 minutes, not more than 7 minutes, not more than 6 minutes, not more than 5 minutes, not more than 4 minutes, not more than 3.5 minutes, not more than 3 minutes, not more than 2.5 minutes, not more than 2 minutes, not more than 1.5 minutes, or not more than 1 minute.

21. The process according to claim 19, wherein the polymer component includes a number of reactive functionalities nᵣ and the curing component includes a curing functionality n_{c} and wherein the resin has a ratio of n_{c}:nᵣ of not greater than 0.98, not greater than 0.95, not greater than 0.9, not greater than 0.85, not greater than 0.8, not greater than 0.75, not greater than 0.7, not greater than 0.65, not greater than 0.6, not greater than 0.55, not greater than 0.5, not greater than 0.45, not greater than 0.4, not greater than 0.38, not greater than 0.36, not greater than 0.34, not greater than 0.32, not greater than 0.30, not greater than 0.28, not greater than 0.26, not greater than 0.24, not greater than 0.22, not greater than 0.2, not greater than 0.18, or not greater than 0.16.

22. The resin composition according to claim 13, wherein the resin composition is an epoxy resin composition comprising:
about 70 wt % to about 95 wt % by weight of the composition of an epoxy component;
and
a curing component comprising about 5 wt % to about 30 wt % by weight of the composition, wherein the curing component includes an imidazole selected from 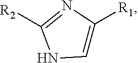
wherein R¹ and R² are not concurrently hydrogen and are selected from the group consisting of amino alkyl, hydroxy alkyl, amino-hydroxy alkyl, and any combination thereof; wherein the epoxy component and the curing component react together at a temperature of about 100° C. to about 130° C. to form a substantially cured reaction product in about 10 minutes or less; wherein the cured reaction product includes:
(i) a tensile strength as determined by ISO 527-1 (2012) of not less than 10,000 psi (68,948 kPa) or a flexural strength as determined by ISO 178 (2010) of not less than 17,000 psi (117,211 kPa); and
(ii) an elongation at break as determined by ISO 527-1 (2012) of at least 2% or a flexural strain as determined by ISO 178 (2010) of at least 4%.

23. The resin composition according to claim 22, wherein the curing component is selected from 2-(3-aminopropyl)-imidazole, 2-(2-aminoethyl)-imidazole, 2-(aminomethyl)-imidazole, 4-(3-aminopropyl)-imidazole, 4-(2-aminoethyl)-imidazole, 4-(aminomethyl)-imidazole, and mixtures thereof.

24. The resin composition according to claim 22, wherein the resin composition has a cured glass transition temperature T_{g} of about 130° C. or greater.

25. The resin composition according to claim 22, wherein the curing component further comprises at least one hardener, wherein the hardener is present in an amount of about 1 wt % to about 25 wt % by weight of the composition, the imidazole is present in an amount of about 5 wt % to about 10 wt % by weight of the composition, and the epoxy component is present in an amount of about 70 wt % to about 94 wt % by weight of the composition; and wherein the hardener is optionally selected from isophorone diamine (‘IPDA’), 1,3-(bis(aminomethyl)cyclohexane (‘BAC’), bis-9p-aminocyclohexyl)methane (‘TALM’), diethylenetriamine (‘DETA’), triethylenetetraamine (‘TETA’), tetraethylenepentamine (‘TEPA’), 4,7,10-trioxatridecane-1,13, or any mixtures thereof.

26. (canceled)

27. The resin composition according to claim 22, wherein the epoxy resin includes any one selected from the group consisting of 2,2-bis-(4-glycidyloxyphenyl)-propane (DGEBA); bis-(4-glycidyloxyphenyl)-methane (‘DGEBF’); bis(3,4-glycidyloxycyclohexylmethyl)oxalate; bis(3,4-glycidyloxycyclohexylmethyl)adipate; bis(3,4-glycidyloxy-6-methylcyclohexylmethyl)adipate; diglycidyloxy vinylyclohexene; diglycidyloxy limonene; triglycidyl-p-aminophenol; N,N,N,N-tetraglycidyl-4,5-methylenebis benzylamine; and any mixtures thereof.

28. A composite product comprising a reaction product of an epoxy resin composition of claim 22.

29. The composite product of claim 28, further comprising a reinforcing fiber, wherein the reinforcing fiber is optionally selected from glass fiber, fiberglass, silicon carbide fiber, disilicon carbide fiber, carbon fiber, graphite fiber, boron fiber, quartz fiber, aluminum oxide fiber, carbon nanotubes, nano composite fibers, polyaramide fiber, poly(p-phenylene benzobisoxazole) fiber, ultrahigh molecular weight polyethylene fiber, high and low density polyethylene fiber, polypropylene fiber, nylon fiber, cellulose fiber, natural fiber, biodegradable fiber, or combinations thereof.

30. (canceled)
